(19) United States
(12) Patent Application Publication
(10) Pub. No.: US 2022/0061135 A1
(43) Pub. Date: Feb. 24, 2022

(54) Systems and Methods for LED Driver Headroom Control

(71) Applicant: Apple Inc., Cupertino, CA (US)

(72) Inventors: Ming Gu, San Jose, CA (US); Yanhui Xie, Cupertino, CA (US); Jingdong Chen, San Jose, CA (US); Asif Hussain, Clearwater, FL (US); Behzad Mohtashemi, Los Gatos, CA (US); Mohammad Jafar Navabi-Shirazi, Phoenix, AZ (US); Linda A. Kamas, Sunnyvale, CA (US); Alejandro Lara Ascorra, Gilbert, AZ (US)

(21) Appl. No.: 17/238,851

(22) Filed: Apr. 23, 2021

Related U.S. Application Data
(60) Provisional application No. 63/067,739, filed on Aug. 19, 2020.

(51) Int. Cl. H05B 45/14; H05B 45/325; G09G 3/34

(52) U.S. Cl. CPC H05B 45/14; G09G 2320/064; G09G 3/342; H05B 45/325

(57) ABSTRACT

Aspects of the subject technology relate to electronic devices having a display. The display includes a channel of light emitting diodes (LEDs) having controllable brightness levels and control circuitry coupled to the channel of LEDs. The control circuitry provides a pulse width modulated (PWM) signal having a duty cycle to control the brightness levels. An adaptive headroom control circuitry is configured to sense a headroom voltage signal for the channel of LEDs and apply a first time period for blanking the headroom voltage signal during the first time period that is associated with a settling time for the headroom voltage signal.

### RELATED APPLICATIONS

This application claims the benefit of priority of U.S. Provisional Application No. 63/067,739 filed Aug. 19, 2020 which is incorporated herein by reference.

### TECHNICAL FIELD

The present description relates generally to electronic devices with light-emitting-diodes, and more particularly, but not exclusively, to electronic devices with light-emitting-diodes with headroom voltage control and pulse-width-modulation.

### BACKGROUND

Electronic devices such as computers, media players, cellular telephones, set-top boxes, and other electronic equipment are often provided with light-emitting-diodes (LEDs) for illuminating portions of the device and/or providing visual indicators of device status.

In some devices, LEDs are included in displays such as organic light-emitting diode (OLED) displays and liquid crystal displays (LCDs) typically include an array of display pixels arranged in pixel rows and pixel columns. Liquid crystal displays commonly include a backlight unit and a liquid crystal display unit with individually controllable liquid crystal display pixels. The backlight unit commonly includes one or more light-emitting diodes (LEDs) that generate light that exits the backlight toward the liquid crystal display unit. The liquid crystal display pixels are individually operable to control passage of light from the backlight unit through that pixel to display content such as text, images, video, or other content on the display.

To improve thermal performance of a LED driver IC, usually three comparators are used to monitor the drain voltage of the LED driver for optimum headroom voltage detection. The detection window is determined by MID and LOW comparator threshold voltages. Once the headroom control logic receives the detection below LOW level or above MID level, a Boost digital-to-analog converter (DAC) reacts with “+1” step with a determined updating time or “−1” step with a determined updating time. Usually the detection window is as wide as a couple of hundred mV. The wider the detection window is, the more extra headroom voltage is “wasted”. Thus, the headroom voltage is not controlled to be at optimal level. As a result, the thermal performance is not optimized.

### SUMMARY

In accordance with various aspects of the subject disclosure, an electronic device with a display is provided, the display includes a channel of light emitting diodes (LEDs) having controllable brightness levels and control circuitry coupled to the channel of LEDs. The control circuitry provides a pulse width modulated (PWM) signal to control the brightness levels. An adaptive headroom control circuitry is configured to sense a headroom voltage signal for the channel of LEDs and apply a first time period for blanking the headroom voltage signal during the first time period that is associated with a settling time for the headroom voltage signal.

In accordance with other aspects of the subject disclosure, a computer implemented method provides voltage supply control of a backlight unit of an electronic device. The computer implemented method includes determining, with control circuitry, whether a light-emitting diode (LED) current of the backlight unit will remain constant, increase, or decrease based on brightness level information and increasing the voltage supply when determining that the LED current will increase in order to provide a voltage response time for the voltage supply.

In accordance with other aspects of the subject disclosure, an electronic device with a display includes a backlight unit having a plurality of light-emitting diodes. A backlight control circuitry includes a voltage supply circuit configured to provide a common supply voltage to the plurality of light-emitting diodes and an adaptive headroom control circuitry is configured to sample a headroom voltage signal for a light-emitting diode during a pulse width modulated (PWM) cycle, compare the headroom voltage signal to a first headroom voltage threshold level and a second headroom voltage threshold level that define a detection window, and determine whether the headroom voltage signal changes from being greater than the first headroom voltage threshold level to being less than the first headroom voltage threshold level during the PWM cycle.

In accordance with other aspects of the subject disclosure, an electronic device with a display includes a backlight unit having a plurality of channels of light-emitting diodes. A backlight control circuitry comprises a voltage supply circuit configured to provide a common supply voltage to the plurality of channels of light-emitting diodes and an adaptive headroom control circuitry is configured to sample headroom voltages for the plurality of channels of light-emitting diode, compare the headroom voltages to a headroom voltage threshold level, and determine whether the headroom voltages are greater than the headroom voltage threshold level during a predetermined number of cycles.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a perspective view of an example electronic device in accordance with various aspects of the subject technology.

FIG. 2 illustrates a block diagram of a side view of an exemplary electronic device display having a backlight unit in accordance with various aspects of the subject technology.

FIG. 3 shows a schematic diagram of exemplary LED control circuitry 300 (e.g., backlight control circuitry that may be implemented in backlight unit 202).

FIG. 4A shows a graph 400 with a LED current signal 410 versus time in PWM mode in accordance with one embodiment.

FIG. 4B shows a graph 450 with a headroom voltage signal 452 versus time in PWM mode in accordance with one embodiment.

FIG. 5 shows LED driver status for different modes of operation in accordance with one embodiment.

FIG. 6 illustrates a computer-implemented method 600 for DC/DC voltage control of a backlight unit of an electronic device in accordance with one embodiment.

FIG. 7 shows a schematic diagram of exemplary LED control circuitry 700 (e.g., backlight control circuitry that may be implemented in backlight unit 202).

FIG. 8 illustrates a graph 800 of headroom voltage versus LED channels in accordance with one embodiment.

FIG. 9 illustrates headroom oscillation in accordance with one embodiment.

FIG. 10 shows a minimum detection window width in accordance with one embodiment.

FIG. 11 illustrates a graph 1100 for headroom voltage versus LED channels in accordance with one embodiment.

FIG. 12 illustrates a graph 1200 that shows LED channel headroom over 1 PWM cycle and also shows output for lower threshold and upper threshold comparators (e.g., comparators 751, 752).

FIG. 13 illustrates a graph 1300 in accordance with one embodiment.

FIG. 14 illustrates a graph 1400 in accordance with one embodiment.

FIGS. 15A and 15B illustrate graphs of headroom voltage versus LED channels for adaptive headroom control that is based on a single comparator in accordance with one embodiment.

FIGS. 16A and 16B illustrate graphs of supply voltage (e.g., DC/DC voltage) versus time (t) for adaptive headroom control that is based on a single comparator in accordance with one embodiment.

FIG. 17 illustrates simulation results for IL[A], V0[V], VLED[V], and ILED[A] versus time for headroom voltage regulation for a LED driver in accordance with one embodiment.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The subject disclosure provides control circuitry for light-emitting diodes (LEDs). The control circuitry includes adaptive headroom voltage control circuitry that ensures that sufficient voltage is supplied to all LEDs while minimizing residual or headroom voltage to avoid unwanted dissipation of power. LED current change or temperature change may cause LED voltage change. With the present design, headroom voltage can properly track LED voltage change. This can improve both efficiency and response of LED driver, especially when brightness needs to track content change.

LEDs may be provided in electronic devices such as cellular telephones, media players, computers, laptops, tablets, set-top boxes, wireless access points, and other electronic equipment. For example, electronic devices may include LEDs in displays that may be used to present visual information and status data and/or may be used to gather user input data, keyboards, flash LEDs, and/or other components. The brightness of the LEDs may be controlled by a pulse-width-modulation (PWM) signal.

Various examples are described herein in the context of LEDs and associated LED control circuitry implemented in display backlights. However, it should be appreciated that these examples are merely illustrative and the disclosed LED control systems and methods described herein may be implemented in other contexts in which PWM and headroom control of LEDs is desired (e.g., for illumination of keyboards, flash components, etc.).

LED control circuitry such as backlight control circuitry includes circuitry for operating one or more strings of LEDs using pulse-width modulation (PWM) to control the brightness of the LEDs. Each string may include one or more LEDs coupled in series between a supply voltage source and a current controller. The supply voltage source may provide a common supply voltage to the LED strings. The LED control circuitry also includes headroom voltage control circuitry that samples a headroom voltage for each string of LEDs and raises or lowers the supply voltage to maintain a desired headroom voltage.

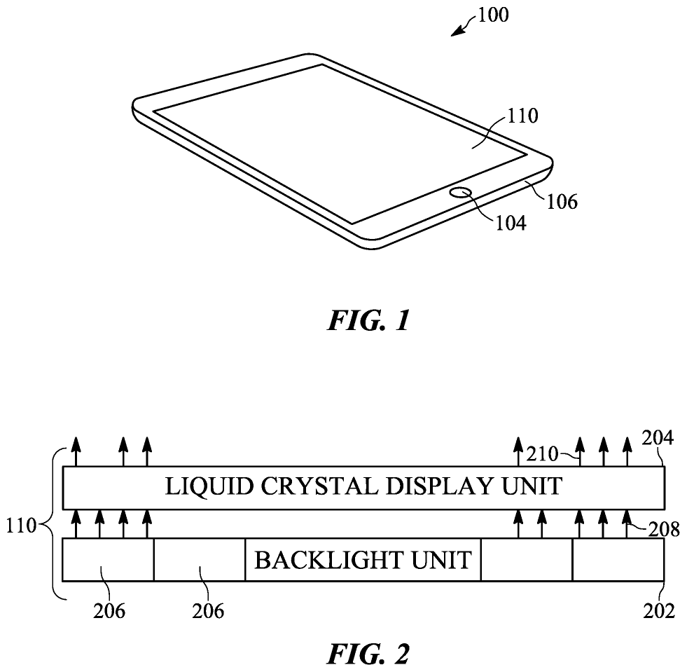

An illustrative electronic device of the type that may be provided with one or more LEDs, and associated LED control circuitry, (e.g., in a display) is shown in FIG. 1. In the example of FIG. 1, device 100 has been implemented using a housing that is sufficiently small to be portable and carried by a user (e.g., device 100 of FIG. 1 may be a handheld electronic device such as a tablet computer or a cellular telephone). As shown in FIG. 1, device 100 may include a display such as display 110 mounted on the front of housing 106. Display 110 may be substantially filled with active display pixels or may have an active portion and an inactive portion. Display 110 may have openings (e.g., openings in the inactive or active portions of display 110) such as an opening to accommodate button 104 and/or other openings such as an opening to accommodate a speaker, a light source, or a camera.

Display 110 may be a touch screen that incorporates capacitive touch electrodes or other touch sensor components or may be a display that is not touch-sensitive. Display 110 may include display pixels formed from light-emitting diodes (LEDs), organic light-emitting diodes (OLEDs), plasma cells, electrophoretic display elements, electrowetting display elements, liquid crystal display (LCD) components, or other suitable display pixel structures. Arrangements in which display 110 is formed using LCD pixels and LED backlights are sometimes described herein as an example. This is, however, merely illustrative. In various implementations, any suitable type of display technology may be used in forming display 110 if desired.

Housing 106, which may sometimes be referred to as a case, may be formed of plastic, glass, ceramics, fiber composites, metal (e.g., stainless steel, aluminum, etc.), other suitable materials, or a combination of any two or more of these materials.

The configuration of electronic device 100 of FIG. 1 is merely illustrative. In other implementations, electronic device 100 may be a computer such as a computer that is integrated into a display such as a computer monitor, a laptop computer, a somewhat smaller portable device such as a wrist-watch device, a pendant device, or other wearable or miniature device, a media player, a gaming device, a navigation device, a computer monitor, a television, or other electronic equipment.

For example, in some implementations, housing 106 may be formed using a unibody configuration in which some or all of housing 106 is machined or molded as a single structure or may be formed using multiple structures (e.g., an internal frame structure, one or more structures that form exterior housing surfaces, etc.). Although housing 106 of FIG. 1 is shown as a single structure, housing 106 may have multiple parts. For example, housing 106 may have upper portion and lower portion coupled to the upper portion using a hinge that allows the upper portion to rotate about a rotational axis relative to the lower portion. A keyboard such as a QWERTY keyboard and a touch pad may be mounted in the lower housing portion, in some implementations.

In some implementations, electronic device 100 may be provided in the form of a computer integrated into a computer monitor. Display 110 may be mounted on a front surface of housing 106 and a stand may be provided to support housing (e.g., on a desktop).

FIG. 2 is a schematic diagram of display 110 showing how the display may be provided with a liquid crystal display unit 204 and a backlight unit 202. As shown in FIG. 2, backlight unit 202 generates backlight 208 and emits backlight 208 in the direction of liquid crystal display unit 204. Liquid crystal display unit 204 selectively allows some or all of the backlight 208 to pass through the liquid crystal display pixels therein to generate display light 210 visible to a user. Backlight unit may include one or more subsections 206. In some implementations, subsections 206 may be elongated subsections that extend horizontally or vertically across some or all of display 110 (e.g., in an edge-lit configuration for backlight unit 202). In other implementations, subsections 206 may be square or nearly square subsections (e.g., in a two-dimensional array backlight configuration). Accordingly, subsections 206 may be defined one or more strings of LEDs disposed in that subsection. Subsections 206 may be controlled individually for local dimming of backlight 208.

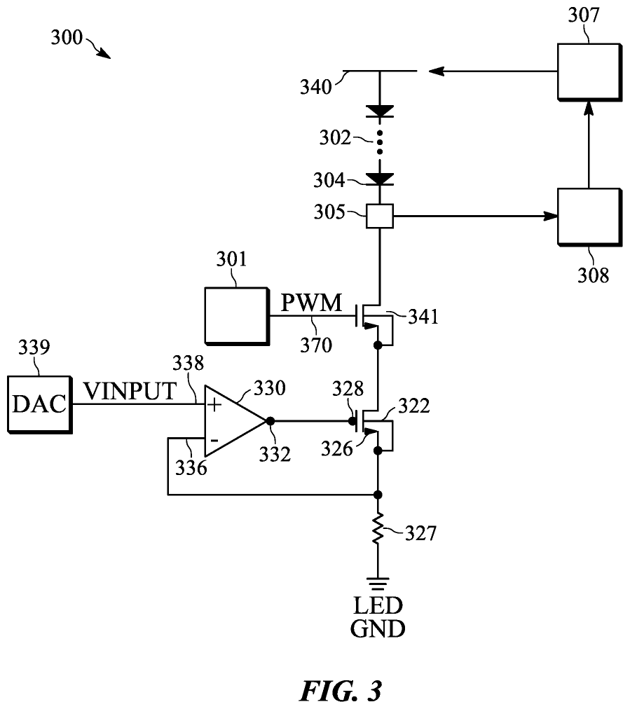

FIG. 3 shows a schematic diagram of exemplary LED control circuitry 300 (e.g., backlight control circuitry that may be implemented in backlight unit 202). In the example of FIG. 3, circuitry 300 includes at least one string 302 (or channel) of LEDs 304. Strings 302 each include one or more LEDs 304 in series. The strings 302 of LEDs 304 receive a common supply voltage 340, at a first end of the string from a common supply voltage source 307 such as a DC/DC converter or switching converter (e.g., implemented as a buck converter, a boost converter, a buck boost converter, or an inverter). Each string 302 of LEDs 304 is also coupled, at a second end of that string 302, to a LED pin 305 and current control circuitry that may include PWM and linear current control. A transistor 341 (e.g., a field effect transistor such as a metal oxide semiconductor field effect transistors, high voltage NMOS) provides PWM control of current through LEDs 304.

In the example of FIG. 3, transistor 322 has a gate terminal 328 coupled to an output 332 of an operational amplifier 330, and a source/drain terminal 326 coupled to a ground voltage through a resistor 327. Amplifier 330 receives, at a first input 338, a reference voltage Vinput from a DAC 339 and, at a second input 336, a feedback voltage from the source/drain terminal 326.

The supply voltage 340 can be adaptively adjusted based on monitoring of the headroom voltage at the end of each string. In the example of FIG. 3, the headroom voltage for string 302 is sampled by adaptive headroom control circuitry 308 at the second end of the string 302 using LED pin 305 via a sampling line of a feedback loop. The sampled headroom voltage may be used by the adaptive headroom control circuitry 308 to operate supply voltage source 307 to provide a supply voltage 340 that ensures that the headroom voltage is within a hysteresis window. The sampled headroom voltage for a string 302 may be a residual voltage at a second end of the string that is opposite the end of the string that is coupled to supply voltage 340. It may be desirable to maintain the residual voltage for all strings at a level that ensures sufficient voltage for the operations of all LEDs in all strings but that reduces or minimizes waste due to power dissipation due to the residual voltages.

Although a single string 302 is shown in FIG. 3, it should be appreciated that multiple LED strings 302 can be coupled in parallel between the common voltage supply source 307 and current control circuitry for that string. In implementations in which multiple strings or channels 302 receive supply voltage 340 from source 307 and provide a headroom voltage to adaptive headroom control circuit 308, the sampled headroom voltage for each string 302 may be compared to upper and lower threshold voltages.

In these multiple channel implementations, if the headroom voltage for any of the LED strings or channels for a PWM cycle is lower than a lower threshold, output voltage 340 can be increased to provide additional headroom. If the headroom voltage of all of the LED channels for the PWM cycle is higher than the upper threshold, output voltage 340 can be decreased.

If the headroom voltage for a LED channel for a PWM cycle falls from being above the upper threshold to being below the upper threshold while above the lower threshold, DC/DC output voltage 340 will not change.

Local dimming of the LEDs in each string may be performed by controlling the current through each string 302 using a PWM signal 370 in which the duty cycle of the PWM signal controls the brightness of the LED. For example, a Switch 341 (e.g., transistor 341) is operated by PWM driver 301. Transistor 322 is operated by controlling a gate voltage for the transistor with a selectable voltage input such as a digital-to-analog converter (DAC) coupled to the gate terminal. As shown in FIG. 3, an operational amplifier 330 may be coupled between DAC 339 and the gate terminal 328 of transistor 322 to provide feedback control of the current through transistor 322. A first input terminal 338 of amplifier 330 receives an output (Vinput) of DAC 339 and a second input terminal 336 of amplifier 330 receives a residual voltage for comparison, by amplifier 330 to the input voltage from DAC 339. The output of amplifier 330 includes an output terminal coupled to the gate terminal of transistor 322. In the example of FIG. 3, the feedback voltage is a residual voltage at a location between transistor 322 and resistor 327. Traditionally, the peak current of LED driver does not change in PWM only dimming mode. A brightness of LED can be adjusted by adjusting PWM duty cycle. A conventional mixed mode dimming method includes both PWM dimming and linear dimming. When the brightness is larger than a switch point, the LED driver is working in linear dimming mode. In this mode, the LED current is adjusted proportional to brightness change. When brightness is lower than the switch point, the LED driver is working in PWM dimming mode. In PWM dimming mode, a forward voltage (V_{f}) applied from anode to cathode to turn ON a LED stays constant since peak current does not change. In linear dimming mode, V_{f} increases monotonically as LED current linearly increases. The variation of V_{f} introduces challenges to LED driver headroom control, especially when brightness is frequently adjusted based on display content.

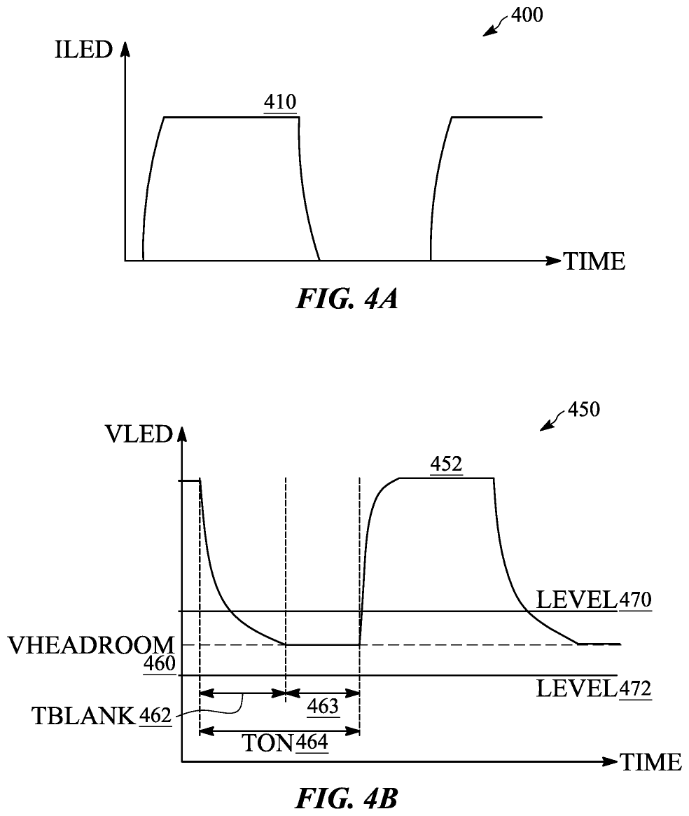

FIG. 4A shows a graph 400 with a LED current signal 410 versus time in PWM mode in accordance with one embodiment. FIG. 4B shows a graph 450 with a headroom voltage signal 452 versus time in PWM mode in accordance with one embodiment. In PWM mode, the headroom voltage takes time to settle. Headroom voltage control provides a control mechanism to control the headroom voltage of a dominant LED string to be within a detection window between levels 470 and 472. To properly control the headroom voltage, headroom voltage sensing can be blanked or removed for a time period (e.g., Tblank 462) that corresponds to the settling time of the headroom voltage since the voltage is not settled yet. When the duty cycle is larger, headroom can still be sensed after Tblank 462 during time period 463. However, if duty cycle is small (e.g., duty cycle less than 10%, duty cycle less than 5%), the PWM on time can be fully blanked with Tblank 462, leaving no time period for headroom sensing for settling of the headroom voltage. In this case, the output voltage of the DC/DC converter is kept at the same target as when the headroom voltage was sensed at larger duty cycles. However, if any LED string has headroom voltage lower than level 472, the output of the DC/DC converter can be commanded to increase based on a supply voltage modification.

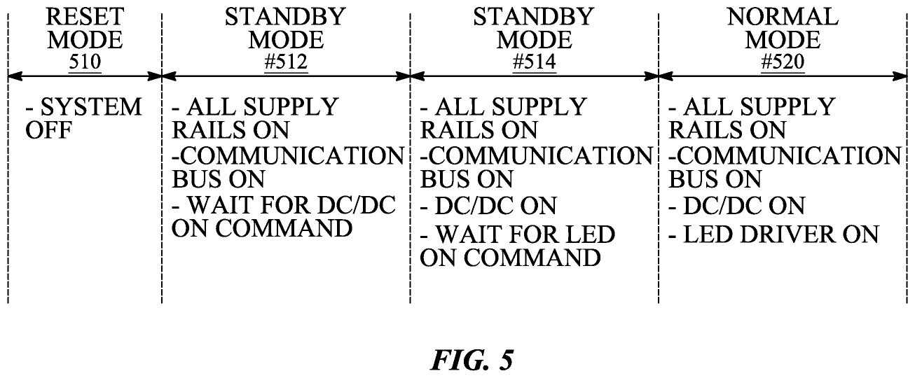

A DC/DC converter (e.g., DC/DC converter 307) has a maximum voltage, Vₘₐₓ. Under any operating conditions, an output of DC/DC converter is less than Vₘₐₓ. However, the DC/DC converter can have an initial voltage that is different from Vₘₐₓ. FIG. 5 shows LED driver status for different modes of operation in accordance with one embodiment.

When the LED control circuitry (e.g., backlight control circuitry that may be implemented in backlight unit 202) transitions to standby mode #514 either from standby mode #512 or from normal mode 520, the output of DC/DC converter can be set as Vᵢₙᵢₜᵢₐₗ, not Vₘₐₓ. This will reduce headroom control range and reduce headroom voltage control loop response time. Thus, the headroom voltage can track the LED current change timely.

The LED control circuitry has a reset mode 510 for an OFF state and a standby mode 512 with all supply rails ON, a communication bus ON, and waiting for DC/DC ON command. The standby mode 514 has all supply rails ON, a communication bus ON, DC/DC converter ON, and waiting for LED ON command. The normal mode 520 has all supply rails ON, a communication bus ON, DC/DC converter ON, and LED driver ON.

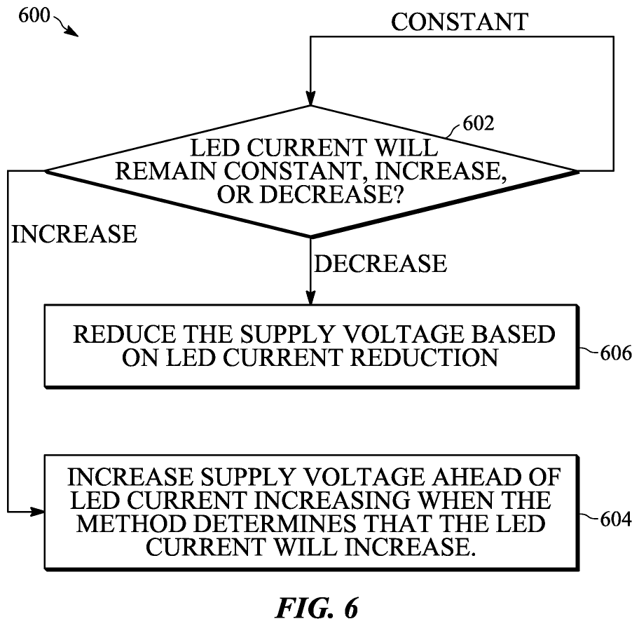

For explanatory purposes, the blocks of the example computer-implemented method 600 for DC/DC voltage control of a backlight unit of an electronic device of FIG. 6 are described herein as occurring in series, or linearly. However, multiple blocks of the example method of FIG. 6 may occur in parallel. In addition, the blocks of the example method of FIG. 6 need not be performed in the order shown and/or one or more of the blocks of the example method of FIG. 6 need not be performed. A backlight unit, display circuitry, control circuitry, matrix drivers, PWM generator, processing circuitry (e.g., processor executing instructions for an algorithm) may perform one or more of the operations of FIG. 6. This circuitry may include hardware (circuitry, dedicated logic, etc.), software (such as is run on a general purpose computer system or a dedicated machine or a device), or a combination of both.

The brightness information is available to a LED driver since this brightness information is needed to control the LED driver. This information can be used for DC/DC voltage control. In the depicted example flow diagram, at operation 602, the method includes determining whether the LED current will remain constant, increase, or decrease.

For example, the DC/DC voltage can be increased ahead of LED current increasing at operation 604 when the method determines that the LED current will increase.

This will give the DC/DC voltage response time to get voltage ready for higher current. Similarly, when the LED control circuitry knows that LED current is or will be decreasing, the DC/DC voltage can be reduced based on LED current reduction at operation 606. This adjustment is purely based on brightness change, not based on headroom sensing.

The voltage target reduction can happen with a certain delay after LED driver current is decreased. This can improve headroom control response since adaptive headroom control is generally slow. In PWM mode, although V_{f} does not change when PWM duty cycle is increased, DC/DC converter output voltage can still be increased in proportion to brightness change, this can reduce headroom loss introduced by load transient of the DC/DC converter.

The method proceeds to return to operation 602 when the LED current remains constant for a time period.

With the present design, headroom voltage can properly track LED current change. This can improve both efficiency and response of LED driver, especially when brightness needs to track content change.

Conventional approaches for voltage headroom detection usually have a detection window that is as wide as a couple of hundred mV. The wider the detection window is, the more extra headroom voltage is “wasted”. Thus, the headroom voltage is not controlled to be at optimal level.

The present design minimizes a detection window for LED driver headroom control. A detection window is still needed since hysteresis is still required for a headroom control loop with an adaptive headroom control logic adjusting a voltage supply based on a sensed headroom voltage from a channel of LEDs. The detection window is minimized to its minimum limit to achieve the minimum headroom voltage while simultaneously keep the hysteresis characteristics. As a result, thermal performance is optimized.

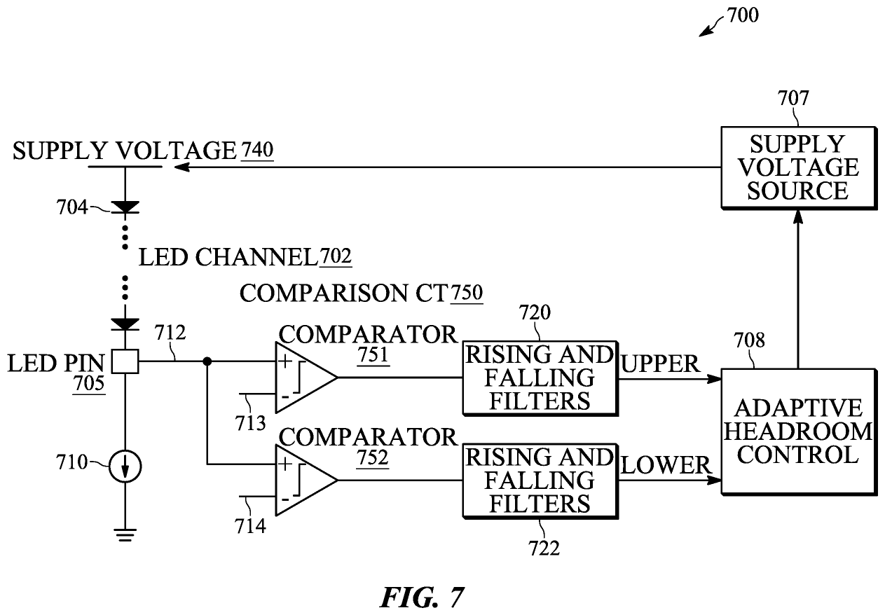

FIG. 7 shows a schematic diagram of exemplary LED control circuitry 700 (e.g., backlight control circuitry that may be implemented in backlight unit 202). In the example of FIG. 7, circuitry 700 includes at least one string or channel 702 of LEDs 704. String 702 includes one or more LEDs 704 in series. The string or channel 702 of LEDs 704 receive a common supply voltage 740, at a first end of the channel from a common supply voltage source 707 (e.g., voltage supply circuitry) such as a DC/DC converter. Each channel 702 of LEDs 704 is also coupled, at a second end of that channel 702 at LED pin 705, to current control circuitry 710 (e.g., current source, current regulation transistor that controls the current through LEDs 704).

The supply voltage 740 can be adaptively adjusted based on a monitoring of the headroom voltage at the end of each channel. In the example of FIG. 7, the headroom voltage for channel 702 is sampled by the adaptive headroom control circuitry 708 at LED pin 705 via a sampling line 712. The sampled headroom voltage may be used by the adaptive headroom control circuit 708 to operate DC/DC converter 707 to provide a supply voltage that ensures that the headroom voltage is within a hysteresis window. The sampled headroom voltage for a channel 702 may be a residual voltage at a second end of the channel that is opposite the end of the channel that is coupled to supply voltage 740. It may be desirable to maintain the residual voltage for all channels at a level that ensures sufficient voltage for the operations of all LEDs in all channels but that reduces or minimizes waste due to power dissipation due to the residual voltages.

A comparison circuit 750 includes at least one comparator (e.g., comparators 751, 752) that is coupled to rising and falling filters 720, 722. Comparator 751 compares the sampled headroom voltage signal 712 to an upper threshold signal 713 while comparator 752 compares the sampled headroom voltage signal 712 to a lower threshold signal 714. The adaptive headroom control circuit 708 receives upper and lower signals from the rising and falling filters. A rising edge filter passes a rising edge of a signal and a falling edge filter passes a falling edge of a signal.

Although a single string or channel 702 is shown in FIG. 7, it should be appreciated that multiple LED channels 702 can be coupled in parallel between the common voltage supply source 707 and current control circuitry for that channel. In implementations in which multiple channels 702 receive supply voltage 740 from source 707 and provide a headroom voltage to headroom control circuit 708, the sampled headroom voltage for each channel 702 may be compared to upper and lower threshold voltages.

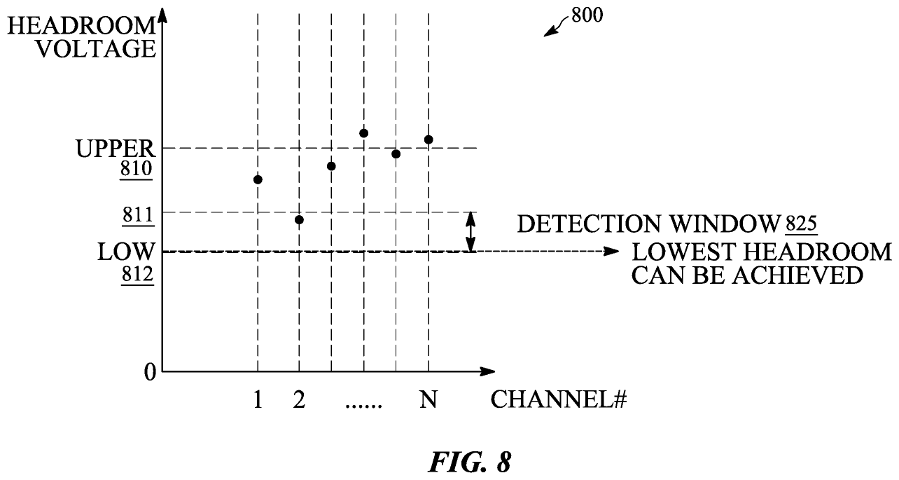

FIG. 8 illustrates a graph 800 of headroom voltage versus LED channels in accordance with one embodiment. A conventional approach would have a detection window that is defined by upper threshold 810 minus lower threshold 812. The detection window 825 of the present design has been reduced for optimal thermal performance. The adaptive headroom control is designed to adjust the DC/DC converter until the headroom voltage for a LED channel having a minimum headroom voltage (e.g., LED channel #2 in FIG. 8) is within the minimized detection window 825 (below a reduced upper threshold 811 and above lower threshold 810). Then the DC/DC output voltage remains constant with no change.

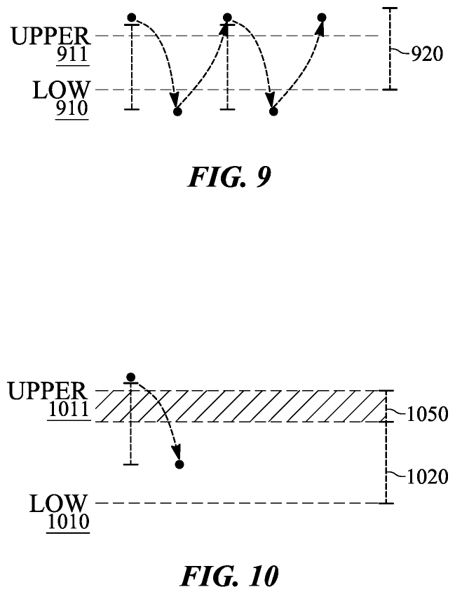

A detection window width between upper threshold level 911 and lower threshold level 910 is designed to be greater than a minimum step size 920 of the LED driver power supply (e.g., DC/DC converter, boost converter, buck converter, buck boost converter, etc.). Otherwise, there will be headroom oscillation as shown in FIG. 9. The detection window width is also designed to account for a comparator offset impact.

FIG. 10 shows a minimum detection window width in accordance with one embodiment. The minimum detection window width between an upper threshold level 1011 and a lower threshold level 1010 is at least one step 1020 of the LED driver power supply plus a comparator offset region 1050. A comparator offset region width can be achieved through Monte Carlo simulations.

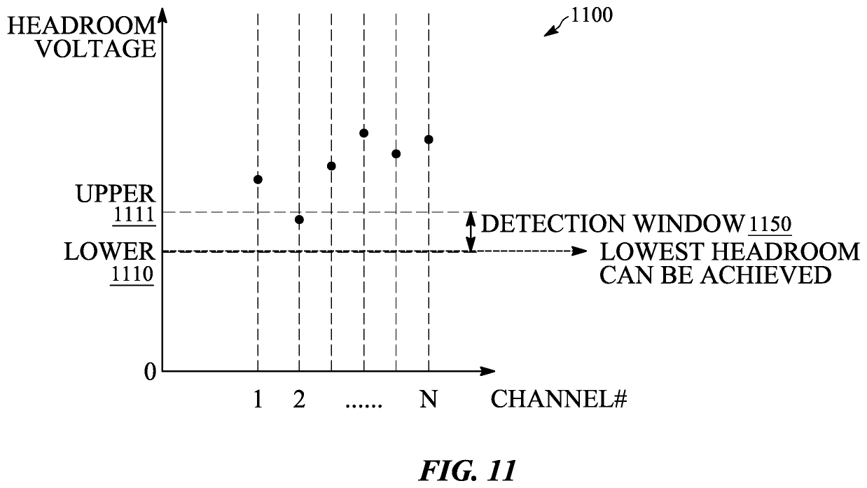

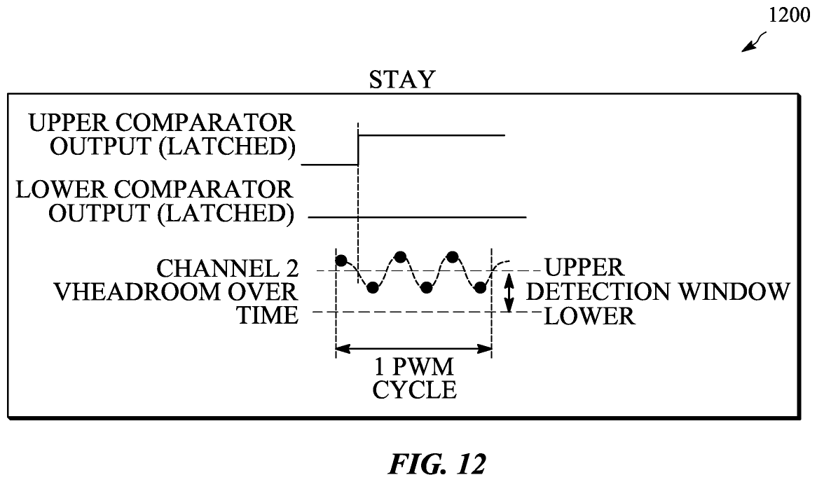

FIG. 11 illustrates a graph 1100 for headroom voltage versus LED channels in accordance with one embodiment. A minimized detection window 1150 is defined by a difference between an upper threshold level 1111 and a lower threshold level 1110. An adaptive headroom control circuitry (e.g, 708, 308) can be operating with stay, down, and up conditions as illustrated in FIGS. 12-14 for LED channel 2 of FIG. 11.

FIG. 12 illustrates a graph 1200 that shows LED channel 2 headroom over 1 PWM cycle and also shows output for lower threshold and upper threshold comparators (e.g., comparators 751, 752). If the headroom voltage for a LED channel 2 for a PWM cycle falls from being greater than the upper threshold 1111 to being less than the upper threshold 1111 as illustrated in FIG. 12, DC/DC output voltage (e.g., 304, 740) will not change due to the headroom voltage oscillating above or below the upper threshold level while remaining greater than the lower threshold 1110. In this case, the output for a comparator for an upper level threshold will be triggered at a high logic level and remains at this high logic level if the headroom voltage oscillates above and below the upper threshold while the comparator with the lower threshold level will not be triggered (output remains at low logic level).

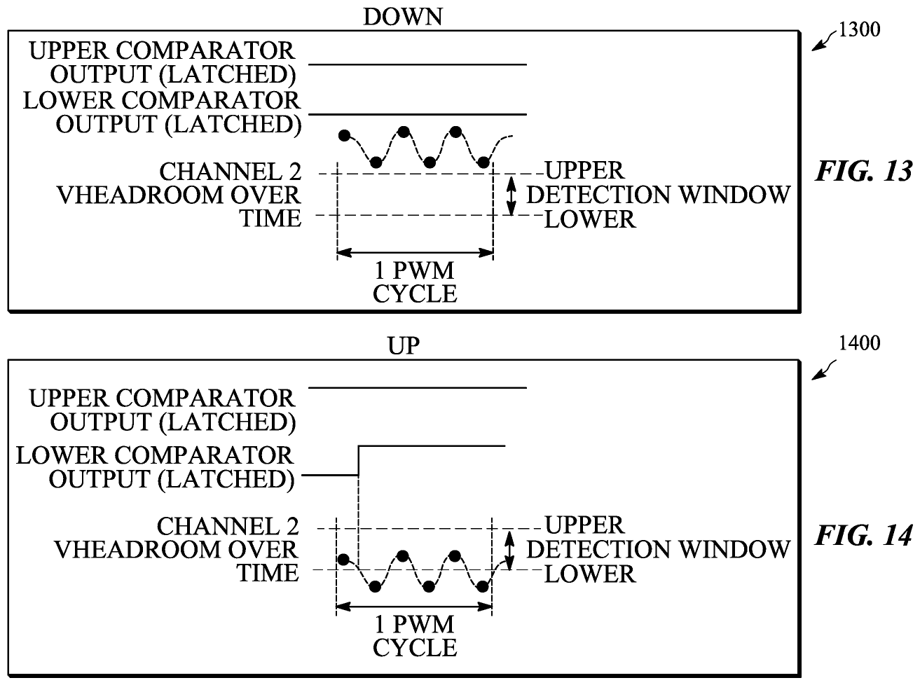

If the headroom voltage of any of the channels (e.g., LED channel 2) for a PWM cycle is continuously higher than the upper threshold level 1111 as illustrated in a graph 1300 of FIG. 13, then the DC/DC output voltage can be decreased. In this case, the comparators with the upper and lower threshold levels will not be triggered when the headroom voltage remains above the upper threshold level.

In multiple channel implementations, if the headroom voltage for any of the LED channels (e.g., LED channel 2) for a PWM cycle is lower than a lower threshold level 1110 as illustrated in FIG. 14, DC/DC output voltage can be increased to provide additional headroom. In this case, the upper level comparator will not be triggered and the output for the comparator with the lower threshold level will be triggered at a high logic level when the headroom voltage falls below the lower threshold level.

One conventional approach has a DC-DC step size of 50 mV, a comparator offset of 50 mV, a ripple of 100 mV, and a detection window width (with 25% margin) of 250 mV.

In one embodiment, the present design includes a DC-DC step size of 50 mV, a comparator offset of 50 mV, and a minimized detection width (with 25% margin) of 125 mV based on (50 mV+50 mV)*1.25. In other embodiments, the present design includes a minimized detection window having a width of 100-175 mV based on a DC-DC step size of 50-125 mV, a comparator offset of 30-50 mV, and a ripple of 100 mV.

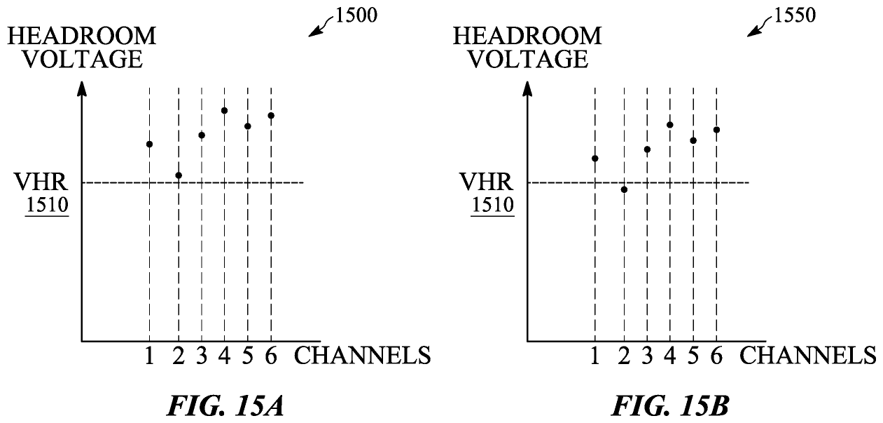

The present design can also be implemented with a single comparator for adaptive headroom control. FIGS. 15A and 15B illustrate graphs of headroom voltage versus LED channels for adaptive headroom control that is based on a single comparator in accordance with one embodiment. FIG. 15A illustrates a first example with all channels having a headroom voltage that is greater than a headroom threshold level 1510 for X cycles. The adaptive headroom control circuitry (e.g., 308) will reduce a DC/DC voltage by N (e.g., 1-5) step sizes of the voltage supply source (e.g., 307). FIG. 15B illustrates a second example that determines whether any channel has a headroom voltage that is less than a headroom threshold level 1510. If so, then the adaptive headroom control circuitry (e.g., 308) will increase a DC/DC voltage by N (e.g., 1-5) step sizes of the voltage supply source (e.g., 307) immediately or nearly immediately after this determination. A frequency of performing the increase of the DC/DC voltage can be set independently and separately from a frequency of performing the decrease of the DC/DC voltage.

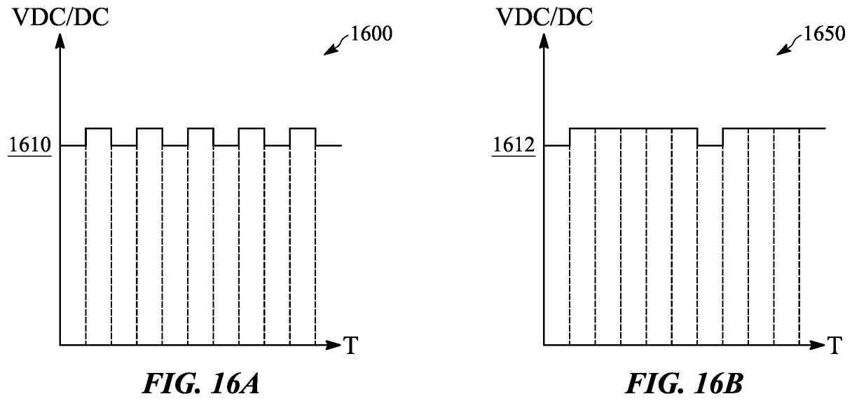

FIGS. 16A and 16B illustrate graphs of supply voltage (e.g., DC/DC voltage) versus time (t) for adaptive headroom control that is based on a single comparator in accordance with one embodiment. FIG. 16A illustrates the first example with a supply voltage signal 1610. If all channels having a headroom voltage that is greater than a headroom threshold level 1510 for X cycles (e.g., 1 cycle), then the adaptive headroom control circuitry (e.g., 308) will reduce a DC/DC voltage by N (e.g., 1-5) step sizes of the voltage supply source (e.g., 307). If any channel headroom voltage is less than the headroom threshold level 1510, then the supply voltage increases by 1 step size immediately.

FIG. 16B illustrates a second example with a supply voltage signal 1612. If the adaptive headroom control circuitry determines that all channels having a headroom voltage that is greater than a headroom threshold level 1510 for X cycles (e.g., 5 cycle), then the adaptive headroom control circuitry decreases the supply voltage by 1 step size. If any channel has a headroom voltage that is less than a headroom threshold level 1510, then the adaptive headroom control circuitry (e.g., 308) will increase the supply voltage by N (e.g., 1-5) step sizes of the voltage supply source (e.g., 307) immediately.

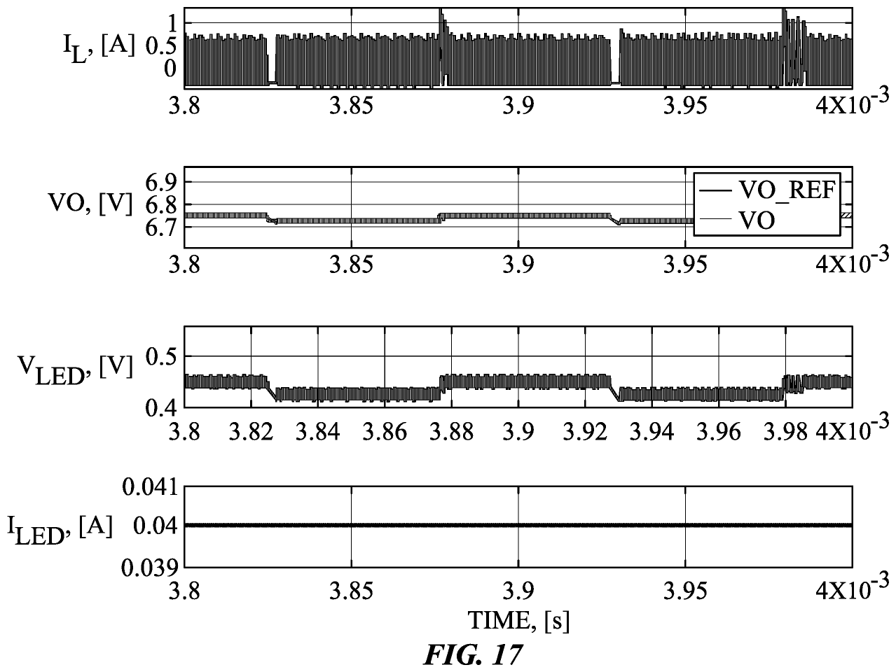

FIG. 17 illustrates simulation results for IL[A], V0[V], VLED[V], and ILED[A] versus time for headroom voltage regulation for a LED driver in accordance with one embodiment. The adaptive headroom control circuitry changes the supply voltage (VO) typically by a step size in response to monitoring a headroom voltage for channels of LEDs. The voltage across a LED changes in response to the changes to the supply voltage.

In accordance with various aspects of the subject disclosure, an electronic device with a display is provided, the display includes a channel of light emitting diodes (LEDs) having controllable brightness levels and control circuitry coupled to the channel of LEDs. The control circuitry provides a pulse width modulated (PWM) signal having a duty cycle to control the brightness levels. An adaptive headroom control circuitry is configured to sense a headroom voltage signal for the channel of LEDs and apply a first time period for blanking the headroom voltage signal during the first time period that is associated with a settling time for the headroom voltage signal.

In accordance with other aspects of the subject disclosure, a computer implemented method provides voltage supply control of a backlight unit of an electronic device. The computer implemented method includes determining, with control circuitry, whether a light-emitting diode (LED) current of the backlight unit will remain constant, increase, or decrease based on brightness level information and increasing the voltage supply when determining that the LED current will increase in order to provide a voltage response time for the voltage supply.

In accordance with other aspects of the subject disclosure, an electronic device with a display includes a backlight unit having a plurality of light-emitting diodes. A backlight control circuitry includes a voltage supply circuit configured to provide a common supply voltage to the plurality of light-emitting diodes and an adaptive headroom control circuitry is configured to sample a headroom voltage signal for a light-emitting diode during a pulse width modulated (PWM) cycle, compare the headroom voltage signal to a first headroom voltage threshold level and a second headroom voltage threshold level that define a detection window, and determine whether the headroom voltage signal changes from being greater than the first headroom voltage threshold level to being less than the first headroom voltage threshold level during the PWM cycle.

In accordance with other aspects of the subject disclosure, an electronic device with a display includes a backlight unit having a plurality of channels of light-emitting diodes. A backlight control circuitry comprises a voltage supply circuit configured to provide a common supply voltage to the plurality of channels of light-emitting diodes and an adaptive headroom control circuitry is configured to sample headroom voltages for the plurality of channels of light-emitting diode, compare the headroom voltages to a headroom voltage threshold level, and determine whether the headroom voltages are greater than the headroom voltage threshold level during a predetermined number of cycles.

Various functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “processor”, and “memory” all refer to electronic or other technological devices. These terms exclude people or groups of people. For the purposes of the specification, the terms “display” or “displaying” means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device as described herein for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Some of the blocks may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “example” is used herein to mean “serving as an example or illustration.” Any aspect or design described herein as “example” is not necessarily to be construed as preferred or advantageous over other aspects or design

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. An electronic device having a display, the display comprising:
a channel of light emitting diodes (LEDs) having controllable brightness levels;
control circuitry coupled to the channel of LEDs, the control circuitry to provide a pulse width modulated (PWM) signal having a duty cycle to control the brightness levels; and
an adaptive headroom control circuitry configured to:
sense a headroom voltage signal for the channel of LEDs; and
apply a first time period for blanking the headroom voltage signal during the first time period that is associated with a settling time for the headroom voltage signal.

2. The electronic device of claim 1, wherein the adaptive headroom control circuitry is configured to determine whether to provide a supply voltage modification to a voltage supply circuit based on the headroom voltage signal during a second time period that follows the first time period.

3. The electronic device of claim 2, wherein the adaptive headroom control circuitry is configured to compare the headroom voltage signal to a first headroom voltage threshold level and a second headroom voltage threshold level that define a detection window and to provide a supply voltage modification to the voltage supply circuit when the headroom voltage is less than the second headroom voltage threshold level.

4. The electronic device of claim 1, wherein the adaptive headroom control circuitry is configured to determine whether the duty cycle is lower than a threshold level and to maintain a voltage of a voltage supply circuit when the duty cycle is lower than the threshold level.

5. The electronic device of claim 4, wherein the channel of LEDs comprises a plurality of light-emitting diodes each having a first end, an opposing second end, and more than one light-emitting diode coupled in series between the first end and the second end, wherein the voltage supply circuit is configured to provide a common supply voltage to the first end of the channel of LEDs.

6. The electronic device of claim 5, wherein the adaptive headroom control circuitry comprises a feedback loop having a sampling line that is coupled to a second end of the channel of LEDs.

7. The electronic device of claim 1, further comprising:
voltage supply circuitry to provide a common supply voltage to the channel of LEDs, wherein the voltage supply circuitry is configured with an initial output voltage below a maximum output voltage when the display transitions from a first standby mode or normal mode to a second standby mode to reduce a headroom control range.

8. The electronic device of claim 1, wherein the control circuitry is configured to determine a brightness level change for the channel of LEDs, to determine a change in current level for the channel of LEDs, and to provide a supply voltage modification to a voltage supply circuit in response to the brightness level change.

9. A computer implemented method for voltage supply control of a backlight unit of an electronic device, comprising:
determining, with control circuitry, whether a light-emitting diode (LED) current of the backlight unit will remain constant, increase, or decrease based on brightness level information; and
increasing the voltage supply when determining that the LED current will increase in order to provide a voltage response time for the voltage supply.

10. The computer implemented method of claim 9, further comprising:
decreasing the voltage supply when determining that the LED current will decrease with this adjustment of the voltage supply being based on a brightness change of the brightness level information.

11. The computer implemented method of claim 10, wherein the decrease of the voltage supply occurs with a certain delay after the LED current is decreased to improve headroom control response.

12. An electronic device with a display, the display comprising:
a backlight unit having a plurality of light-emitting diodes; and
backlight control circuitry, comprising:
a voltage supply circuit configured to provide a common supply voltage to the plurality of light-emitting diodes; and
adaptive headroom control circuitry configured to:
sample a headroom voltage signal for a light-emitting diode during a pulse width modulated (PWM) cycle;
compare the headroom voltage signal to a first headroom voltage threshold level and a second headroom voltage threshold level that define a detection window; and
determine whether the headroom voltage signal changes from being greater than the first headroom voltage threshold level to being less than the first headroom voltage threshold level during the PWM cycle.

13. The electronic device of claim 12, wherein the adaptive headroom control circuitry is further configured to provide no adjustment to the voltage supply circuit when the headroom voltage signal changes from being greater than the first headroom voltage threshold level to being less than the first headroom voltage threshold level during the PWM cycle.

14. The electronic device of claim 12, wherein the adaptive headroom control circuitry is further configured to determine that the headroom voltage signal during the PWM cycle is continuously greater than the first headroom voltage level and to provide a supply voltage modification to the voltage supply circuit to decrease the common supply voltage in response to this determination that the headroom voltage signal during the PWM cycle is continuously greater than the first headroom voltage level.

15. The electronic device of claim 12, wherein the adaptive headroom control circuitry is further configured to determine if any voltages of the headroom voltage signal during the PWM cycle are less than the second headroom voltage level and to provide a supply voltage modification to the voltage supply circuit to increase the common supply voltage in response to this determination that any of the voltages during the PWM cycle are less than the second headroom voltage level.

16. The electronic device of claim 12, wherein the adaptive headroom control circuitry comprises:
a first comparator to compare the headroom voltage signal to the first headroom voltage threshold level; and
a second comparator to compare the headroom voltage signal to the second headroom voltage threshold level.

17. The electronic device of claim 12, wherein the detection window is based on a voltage step of the voltage supply circuit and a comparator offset of the first comparator or the second comparator.

18. The electronic device of claim 12, wherein the detection window is minimized to provide a minimum headroom voltage while maintaining hysteresis for a headroom control loop.

19. An electronic device with a display, the display comprising:
a backlight unit having a plurality of channels of light-emitting diodes; and
backlight control circuitry, comprising:
a voltage supply circuit configured to provide a common supply voltage to the plurality of channels of light-emitting diodes; and
adaptive headroom control circuitry configured to:
sample headroom voltages for the plurality of channels of light-emitting diode;
compare the headroom voltages to a headroom voltage threshold level; and
determine whether the headroom voltages are greater than the headroom voltage threshold level during a predetermined number of cycles.

20. The electronic device of claim 19, wherein the adaptive headroom control circuitry is further configured to provide a supply voltage modification to the voltage supply circuit to decrease the common supply voltage in response to the determination that the headroom voltages are greater than the headroom voltage threshold level during a predetermined number of cycles.

21. The electronic device of claim 19, wherein the adaptive headroom control circuitry is further configured to determine whether any channel has a headroom voltage that is less than the headroom threshold level.

22. The electronic device of claim 19, wherein the adaptive headroom control circuitry is further configured to provide a supply voltage modification to the voltage supply circuit to increase the common supply voltage in response to this determination that any channel has a headroom voltage that is less than the headroom threshold level.

23. The electronic device of claim 19, wherein the adaptive headroom control circuitry comprises:
a single comparator to compare the headroom voltages to the headroom voltage threshold level.
